(19) United States
(12) Patent Application Publication
(10) Pub. No.: US 2014/0240260 A1
(43) Pub. Date: Aug. 28, 2014

(54) METHOD AND APPARATUS FOR PROVIDING USER INTERFACE

(71) Applicant: Samsung Electronics Co., Ltd., Gyeonggi-do (KR)

(72) Inventors: Hong-Sik Park, Seoul (KR); Min-Soo Kwon, Seoul (KR); Chang-Mo Yang, Gyeonggi-do (KR); Jong-Ho Han, Gyeonggi-do (KR); Jee-Yeun Wang, Seoul (KR); Yong-Gu Lee, Gyeonggi-do (KR); Kang-Sik Choi, Busan (KR)

(73) Assignee: Samsung Electronics Co., Ltd., Gyeonggi-do (KR)

(21) Appl. No.: 14/189,334

(22) Filed: Feb. 25, 2014

(30) Foreign Application Priority Data
Feb. 25, 2013 (KR) 10-2013-0019862

(51) Int. Cl. G06F 3/041; G06F 3/01

(52) U.S. Cl. CPC G06F 3/0416; G06F 3/041; G06F 3/016
USPC 345/173

(57) ABSTRACT

Methods and apparatus are provided for providing a user interface. At least one object is displayed on a touch screen. Hovering of at least one input medium over the touch screen is detected. A first visual effect is provided based on where the input medium hovers over the touch screen and based on an attribute of the at least one object.

### PRIORITY

This application claims priority under 35 U.S.C. §119(a) to a Korean patent application filed on Feb. 25, 2013 in the Korean Intellectual Property Office and assigned Serial No. 10-2013-0019862, the entire disclosure of which is incorporated herein by reference.

### BACKGROUND

1. Field of the Invention

The present disclosure relates generally to a method and an apparatus for providing a user interface, and more particularly, to a method and an apparatus for providing a visual effect on a user interface.

2. Description of the Related Art

Mobile terminals, such as smartphones, have come into wide use. They provide various user interfaces using touch screens.

Technologies for providing such user interfaces are currently being developed to provide a user experience that exceeds a user's demands for convenience.

### SUMMARY OF THE INVENTION

The present invention has been made to address at least the above problems and/or disadvantages and to provide at least the advantages described below. Accordingly, an aspect of the present invention provides a user interface that may improve user experiences.

In accordance with an aspect of the present invention, a method is provided for providing a user interface. At least one object is displayed on a touch screen. Hovering of at least one input medium over the touch screen is detected. A first visual effect is provided based on where the input medium hovers over the touch screen and based on an attribute of the at least one object.

In accordance with another aspect of the present invention, an apparatus for providing a user interface is provided. The apparatus includes a touch screen for displaying at least one object and detecting proximity or contact of at least one input medium. The apparatus also includes a controller configured to control the touch screen to detect proximity and hovering of the at least one input medium and provide a first visual effect on the touch screen based on where the input medium hovers over the touch screen and based on an attribute of the at least one object.

### BRIEF DESCRIPTION OF THE DRAWINGS

The above and aspects, features, and advantages of the present invention will become more apparent from the following detailed description when taken in conjunction with the accompanying drawings, in which:

FIG. 1 is flowchart illustrating a method for providing a user interface, according to an embodiment of the present invention;

FIGS. 2A-2B, 3A-3D, 4A-4E, 5A-5C, 6, and 7A-7B illustrate how to provide visual effects, according to embodiments of the present invention;

FIGS. 8A-8C illustrate how to provide acoustic effects, according to an embodiment of the present invention;

FIGS. 9A-9C illustrate how to provide visual effects, according to another embodiment of the present invention; and

FIG. 10 is a block diagram illustrating a terminal to which embodiments of the present disclosure are applied.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

It will be understood that, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present disclosure. Descriptions shall be understood as to include any and all combinations of one or more of the associated listed items when the items are described by using the conjunctive term “˜ and/or ˜,” or the like.

The terminology used herein is for the purpose of describing particular embodiments only and is not intended to be limiting of the disclosure.

It is to be understood that the singular forms “a,” “an,” and “the” include plural references unless the context clearly dictates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A method for providing a user interface, according to various embodiments of the present invention, includes detecting the presence of a nearby input medium, i.e., detecting proximity of the input medium, allowing the user to hover over with the input medium, and providing a visual effect for the user based on where the hover point of the input medium is. In some embodiments of the present invention, the visual effect may be determined based on an attribute of an object displayed on the touch screen. The attribute of an object as used herein may be a color at the hover point.

In various embodiments of the present invention, the term ‘input media’ may refer to a part of a human body, e.g., the user's finger, or any input means, such as, for example, an electronic pen. The term ‘hover point’ may refer to a position of an input medium, the proximity of which is detected, on the touch screen.

In various embodiments of the present invention, the visual effect may include various effects that may indicate proximity, hovering, contact, and move-away of the input medium to the user. For example, the visual effect may include at least one of a lighting effect, a shadow effect, a blur effect, a brightness and contrast effect, a saturation contrast effect, and a ripple effect. In some embodiments of the present invention, these visual effects may be applied simultaneously.

The method for providing a user interface, according to some embodiments of the present invention, may detect a contact of a hovering input medium with the touch screen, and provide a visual effect to the user based on where the contact point of the input medium is. In an embodiment of the present invention, the contact point may refer to a point where the hovering input medium contacts the touch screen.

Also, in some embodiments of the present invention, the visual effect may be provided on a separate layer from a layer on which an object is displayed. In some embodiments of the present invention, the visual effect may be provided by applying alpha blending onto existing layers.

Further, the visual effect, according to various embodiments of the present invention, may be provided not only in a normal use condition of the terminal but also in a screen-locked state in which at least some functions of the terminal is restricted. For this, even in the screen-locked state, the presence of a nearby input medium and hovering of the input medium may be detected.

The visual effect, according to some embodiments of the present invention, may vary depending on the types of the input medium. For example, different visual effects may be provided respectively for a case where a body part, e.g., a finger, is detected and a case where an input device, e.g., an electronic pen, is detected.

In the following description, it is assumed that various embodiments of the present invention are embodied in a terminal, and that the terminal is equipped with a touch screen.

The terminal may refer to devices that enable recording and display of various objects, including cell phones, smartphones, tablets, Global Positioning Systems (GPSs), Personal Digital Assistants (PDAs), Portable Multimedia Players (PMPs), Moving Picture Experts Group layer 3 (MP3) players, netbooks, desktop computers, notebook computers, communication terminals able to connect to the Internet, communication terminals able to receive broadcast signals, etc.

In various embodiments of the present disclosure, the term ‘objects’ may refer to letters, numerals, marks, symbols, figures, photos, images, videos, or any combination thereof.

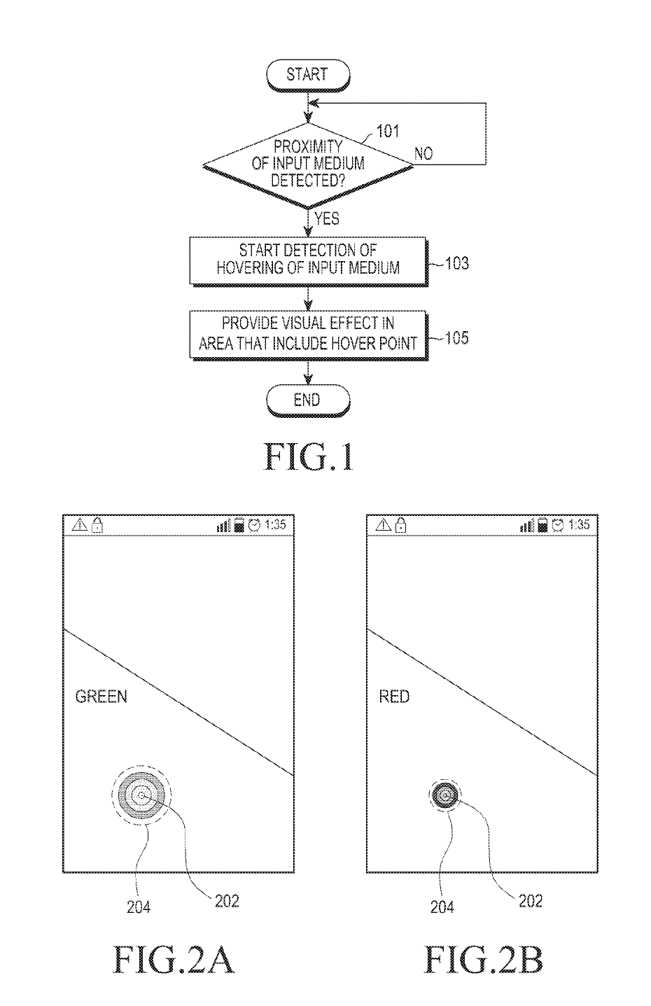

FIG. 1 is flowchart illustrating a method for providing a user interface, according to an embodiment of the present invention.

In step 101, the terminal may determine whether proximity of an input medium has been detected. The proximity of an input medium, as used herein, may refer to the input medium approaching within a predetermined threshold distance of the touch screen of the terminal. Before step 101, the terminal may display at least one object on the touch screen. For example, the terminal may display a background screen including a single image, or display one or more objects on the background screen, such as time, weather, icons that are assigned with various functions, etc. In some embodiments of the present invention, the terminal may provide a predetermined acoustic effect if proximity of the input medium is detected.

If proximity of the input medium is detected, the terminal starts detection of hovering of the input medium, in step 103. In some embodiments of the present invention, starting detection of hovering may include providing a visual effect in an area that includes a hover point of the input medium, the proximity of which has been detected in step 101.

In step 105, the terminal provides a visual effect in an area that includes a hover point of the hovering input medium. The area that includes the hover point may be a circular area centered at the hover point. In other embodiments of the present invention, the area that includes the hover point may be in the form of a closed curve or a polygon. The hover point used herein may include a point at which proximity of the input medium is detected. In an embodiment of the present invention, providing the visual effect may be performed based on a position of the hovering input medium and an attribute of the object. The position of the input medium may include at least one of horizontal points and vertical points of the input medium.

In other embodiments of the present invention, steps 103 and 105 may be performed in reverse order.

According to the embodiment of the present invention described above with respect to FIG. 1, if the terminal detects proximity of the user, the terminal may provide a visual effect to the user, thereby improving the user experience.

Embodiments of the present invention, which provide a visual effect while an input medium is hovering are described in greater detail below.

In an embodiment of the present invention, providing the visual effect may depend on the attribute of an object displayed on the touch screen. The attribute of the object may be e.g., a color of the object. Specifically, in an embodiment of the present invention, the terminal may provide different visual effects depending on the color of an object located at the hover point of the hovering input medium, as described with reference to FIGS. 2A and 2B.

FIGS. 2A and 2B illustrate an example of providing a lighting effect as the visual effect in an area 204 that includes a hover point 202. As described above, the terminal may provide different visual effects depending on the color of an object located at the hover point 202. For example, the terminal may provide the visual effect by varying the size of the area 204 for providing the visual effect depending on the color of an object located at the hover point 202.

For example, compared with a case where the color of an object located at the hover point 202 is green, as shown in FIG. 2A, the area 204 for providing the visual effect may decrease in size when the color of an object located at the hover point 202 is red, as shown in FIG. 2B.

In some embodiments of the present invention, depending on an attribute of the object, the visual effect may be provided by varying at least one of brightness, saturation, and transparency.

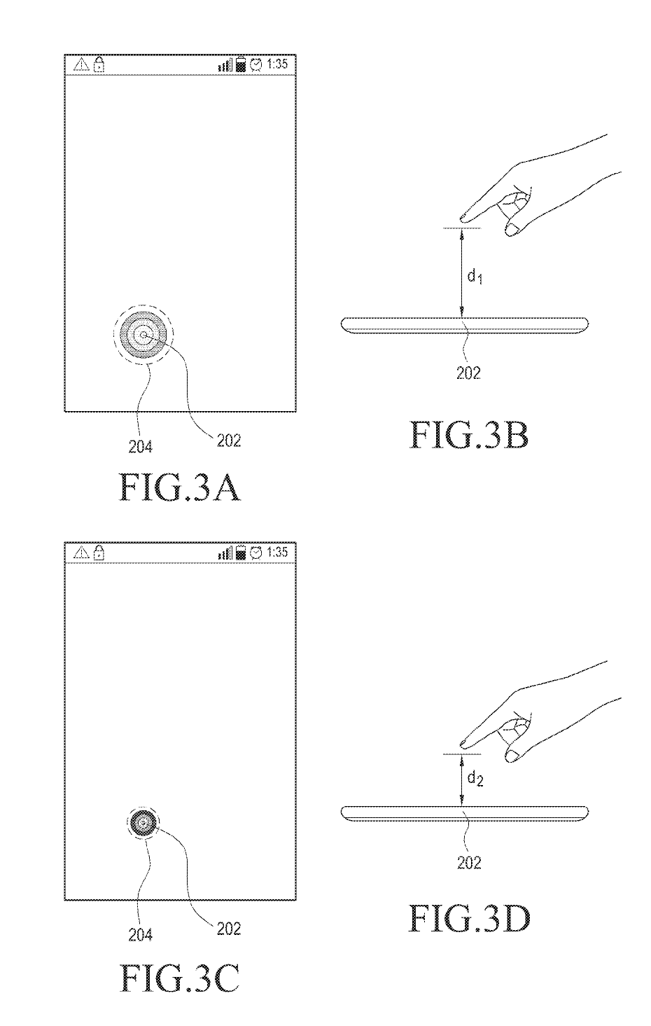

In an embodiment of the present invention, providing the visual effect may depend on a distance between the hovering input medium and the touch screen, as described with reference to FIGS. 3A-3D. The distance may be a vertical gap between the hovering input medium and the touch screen.

In an embodiment of the present invention, as the distance between the input medium and the touch screen decreases, the terminal may provide the visual effect in a relatively small area, and as the distance between the input medium and the touch screen increases, the terminal may provide the visual effect in a relatively large area.

For example, if a distance d1 between the input medium and the touch screen is relatively far, as shown in FIG. 3B, the visual effect may be provided in the relatively large area 204, as shown in FIG. 3A. On the other hand, if a distance d2 between the input medium and the touch screen is relatively close, as shown in FIG. 3D, the visual effect may be provided in the relatively small area 204, as compared with the case of the distance d1, as shown in FIG. 3C.

However, the relative sizing may apply the other way around. Specifically, as the distance between the input medium and the touch screen increases, the terminal may provide the visual effect in a relatively small area, and as the distance between the input medium and the touch screen decreases, the terminal may provide the visual effect in a relatively large area.

In an embodiment of the present invention, providing the visual effect may be performed by decreasing or increasing at least one of brightness, saturation, and transparency. For example, the visual effect, e.g., a lighting effect, may be provided by decreasing at least one of brightness, saturation, and transparency, as a distance from the center of the area 204 increases.

In an embodiment of the present invention, providing the visual effect may be performed by varying brightness, saturation, and transparency depending on the size of the area 204 for providing the visual effect. For example, as the size of the area 204 increases, the visual effect may be provided by decreasing at least one of brightness, saturation, and transparency, or as the size of the area 204 decreases, the visual effect may be provided by increasing at least one of brightness, saturation, and transparency.

Providing the visual effect by decreasing or increasing at least one of brightness, saturation, and transparency and by varying at least one of brightness, saturation, and transparency may be applied to various embodiments of the present disclosure, as described with reference to FIGS. 1 to 10.

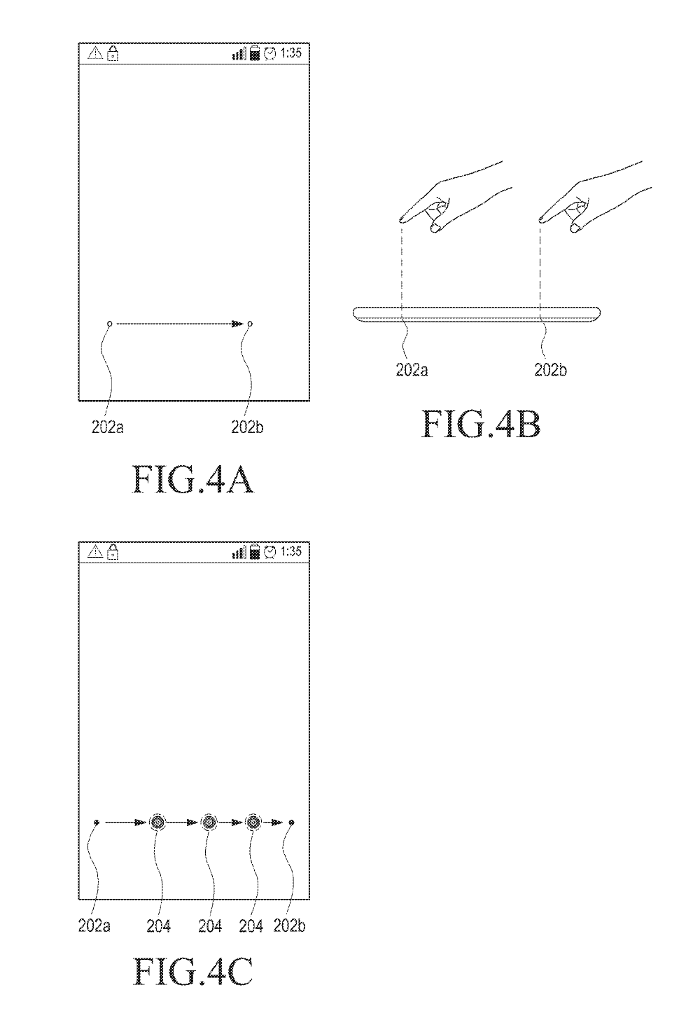

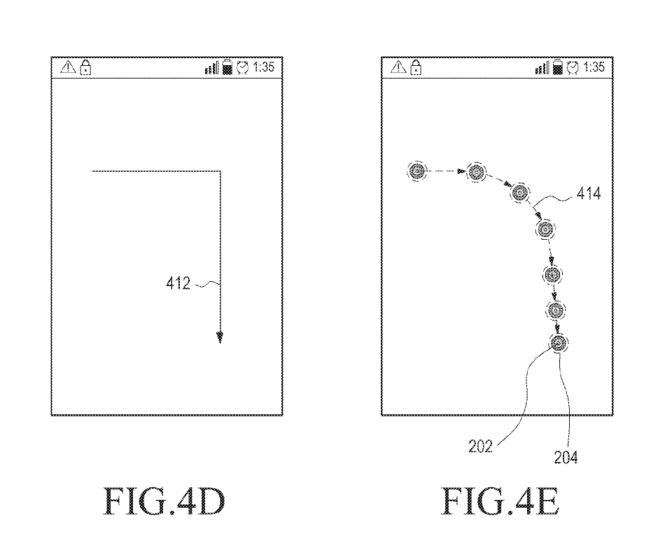

In an embodiment of the present invention, providing the visual effect may be performed in an area that includes a hover point of the hovering input medium or in an area that moves along the hover point of the hovering input medium. For example, if the input medium is moving fast, an effect by which the area for providing the visual effect smoothly movies along with the hover point may be given by applying acceleration for the area, as described in greater detail below with reference to FIGS. 4A-4E.

As shown in FIG. 4B, if the input medium moves from a first hover point 202a to a second hover point 202b, the terminal may provide a visual effect in an area that includes the second hover point 202b immediately after providing a visual effect in an area that includes the first hover point 202a, as shown in FIG. 4A. As the distance between the first and second hover points 202a and 202b increases, the user experience may be degraded due to an immediate change in the area for providing the visual effect.

Accordingly, in an embodiment of the present invention, as the hover point changes, the visual effect may be provided in an area that moves with acceleration between the previous hover point and the current hover point. For example, as shown in FIG. 4C, the visual effect may be provided in areas 204 that move with acceleration from the first hover point 202a to the second hover point 202b.

Providing the visual effect based on acceleration may render the movement of the input medium smooth, thereby improving the user experience. For example, if a hovering trace 412 of the input medium is a straight line, as shown in FIG. 4D, providing an acceleration based visual effect may render a trace 414 of the areas 204 smooth in a curved form.

In an embodiment of the present invention, the position of the area 204 that moves with acceleration, i.e., a position X of the area for providing the visual effect in a current frame may be defined by Equation (1) below. A deceleration constant is a value for controlling velocity/acceleration depending on settings.

$$X = {X}^{′} + \frac{( P - {X}^{′} )}{A} \qquad ( 1 )$$

X represents a position of an area for providing the visual effect in the current frame, X′ represents a position where the visual effect was provided in the previous frame, P represents a current hover point of the input medium, and A represents a deceleration constant.

In an embodiment of the present invention, providing the visual effect may be performed by taking into account a moving direction of the hovering input medium.

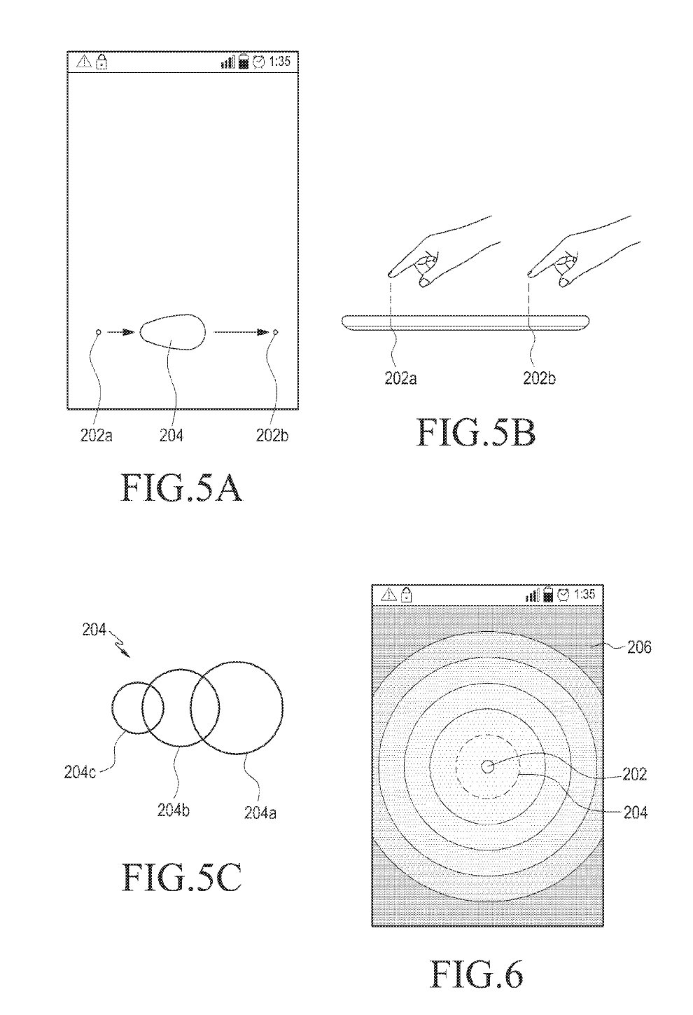

For example, if the hover point of the input medium has moved from the first hover point 202a to the second hover point 202b, as shown in FIG. 5B, the terminal may provide the visual effect in the area 204 having an oval form angled toward one direction, as shown in FIG. 5A. For example, the terminal may give a tail effect as if a tail of the input medium appears in the opposite direction in which the input medium moves.

In an embodiment of the present invention, providing the tail effect may be performed by providing the visual effect in each of two sub-areas that move along the hover point 202b with different acceleration or different velocity. For example, as shown in FIG. 5C, visual effects may be provided in sub-areas 204a, 204b, and 204c having different sizes, respectively, such that all the sub-areas move along the hover point 202b with different acceleration or different velocity, thereby giving the tail effect. In an embodiment of the present invention, the area 204a, which is the nearest to the second hover point 202b, may be determined to have the largest size.

Alternatively, providing the visual effect may be performed in areas (hereinafter, referred to as a second area) other than areas that include the hover point, i.e., the areas as described with reference to FIGS. 2 to 5 (hereinafter, referred to as a first area).

For example, as shown in FIG. 6, the terminal may provide the visual effect in a second area 206, which is all of the screen area except for the first area 204. The visual effect may be, for example, changing at least one of brightness, saturation, and transparency of the second area 206. Changing at least one of brightness, saturation, and transparency may be performed such that at least one of brightness, saturation, and transparency gradually increases or decreases as a distance from the center of the second area 206 increases.

In an embodiment of the present invention, there may be one or more hovering input media. If there are two or more input media, the terminal may provide visual effects in areas that include hover points of the input media. In this case, providing visual effects for respective input media by increasing or decreasing at least one of brightness, saturation, and transparency in the area for providing the visual effect for each input medium may be performed based on sizes of and distances from respective input media.

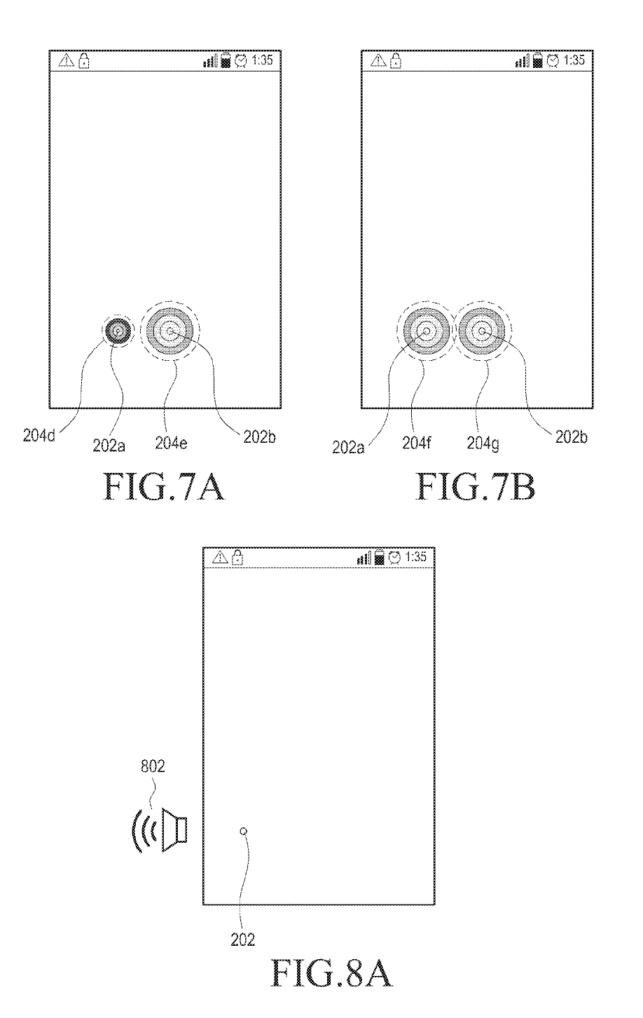

For example, as shown in FIG. 7A, if the input medium is small in size and distant from the touch screen, the terminal may provide a visual effect in a narrower area 204d, and if the input medium is big in size and close to the touch screen, the terminal may provide a visual effect in a wider area 204e.

In providing visual effects for two or more input media, the visual effects may be changed based on the distance between hover points of the input media. For example, as shown in FIG. 7B, if the distance between hover points of the input media is close, visual effects for the respective input media may overlap with each other or one visual effect may be shared with another.

For example, if hover points of input media are within a predetermined distance although the input media are different in size or keep different distances to the touch screen, a visual effect for an input medium may be shared with a visual effect for another input medium. Specifically, when visual effects are shared with each other and areas for providing visual effects for input media are different in size, as shown in FIG. 7A, the area 204f may be shared with the area 204g such that visual effects may be provided for the areas 204f and 204g to have the same size.

In some embodiments of the present invention, the visual effect may be provided with an acoustic effect. For example, if proximity of an object is detected and the object moves while hovering over the touch screen, the terminal may provide an acoustic effect together with or independently from the visual effect.

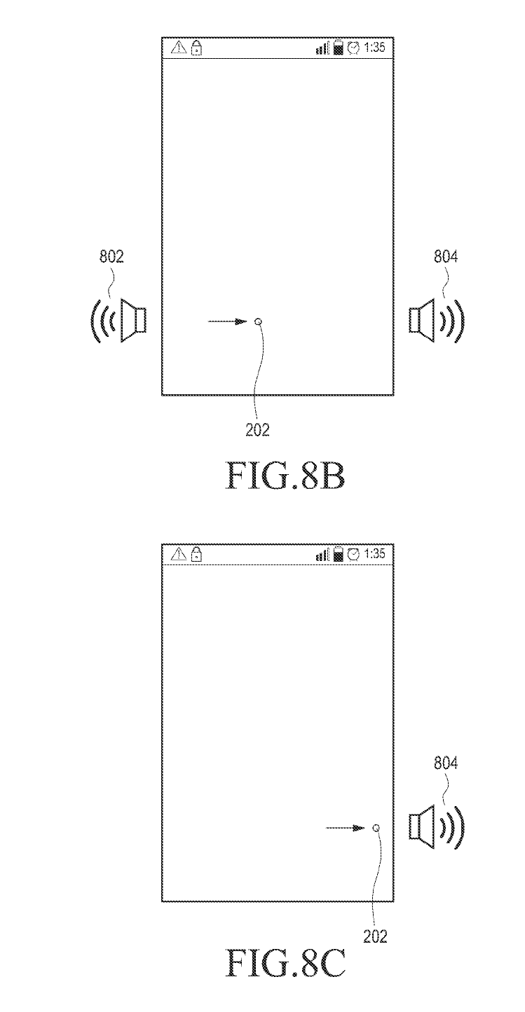

The terminal may provide the acoustic effect as a sound panning effect by taking into account where the hover point is. For example, if the hover point 202 of an input medium is on the left of the screen, as shown in FIG. 8A, the terminal may control a sound to be outputted through a left speaker 802. If the hover point 202 of the input medium is on the center of the screen, the terminal may control a sound to be outputted through both left and right speakers 802 and 804, as shown in FIG. 8B. If the hover point 202 of the input medium is on the right of the screen, the terminal may control a sound to be outputted through the right speaker 804, as shown in FIG. 8C.

Specifically, the terminal may give the sound panning effect by controlling speaker outputs based on where the hover point is.

In an embodiment of the present invention, providing the acoustic effect may be performed based on an attribute of an object. For example, the object may be a background image, and the terminal may provide different acoustic effects depending on the types of the background image. For example, if the background image depicts the ocean, an acoustic effect associated with the ocean, such as the sound of water or the sound of waves, may be provided, and if the background image depicts a vehicle, an acoustic effect associated with the vehicle, such as the sound of a car engine, may be provided.

The attribute of the object, e.g., the attribute of the background image, may be obtained by analyzing metadata or tag information attached to the background image. Specifically, the attribute of the background image may be extracted by analyzing metadata or tag information attached to the background image, and if there is a pre-stored sound source corresponding to the attribute, an acoustic effect may be provided using the sound source.

If an object, e.g., the background image has no metadata or tag information attached thereto, or there is no pre-stored sound source corresponding to the background image, the terminal may obtain information regarding the background image through a network. Obtaining information regarding the background image through a network may be performed by a procedure of extracting multiple features from the background image and sending the features to a server to request the server for the attribute of the background image.

In an embodiment of the present invention, if the terminal provides a lighting effect in an area that includes a hover point, the terminal may give a shadow effect in the area that includes the hover point or the entire display area. In an embodiment of the present invention, the shadow effect may be applied in areas except for some objects displayed in the display area, e.g., time display text or particular icons. Alternatively, the shadow effect may also be applied to all the objects displayed in the display area. Providing the shadow effect may be performed by extracting edge parts of pixels included in each object and rendering the edge parts darker.

In an embodiment of the present invention, providing the visual effect may vary depending on ambient light of the terminal. For example, the terminal may provide a visual effect by varying at least one of brightness, saturation, and transparency, or varying the size of the area for providing the visual effect. For example, with intense ambient light, the terminal may make the area for providing the visual effect smaller. In another example, with intense ambient light, the terminal may apply the visual effect by increasing at least one of brightness, saturation, and transparency.

In an embodiment of the present invention, if the hovering input medium contacts the touch screen, the terminal may provide a visual effect in an area that includes the contact point.

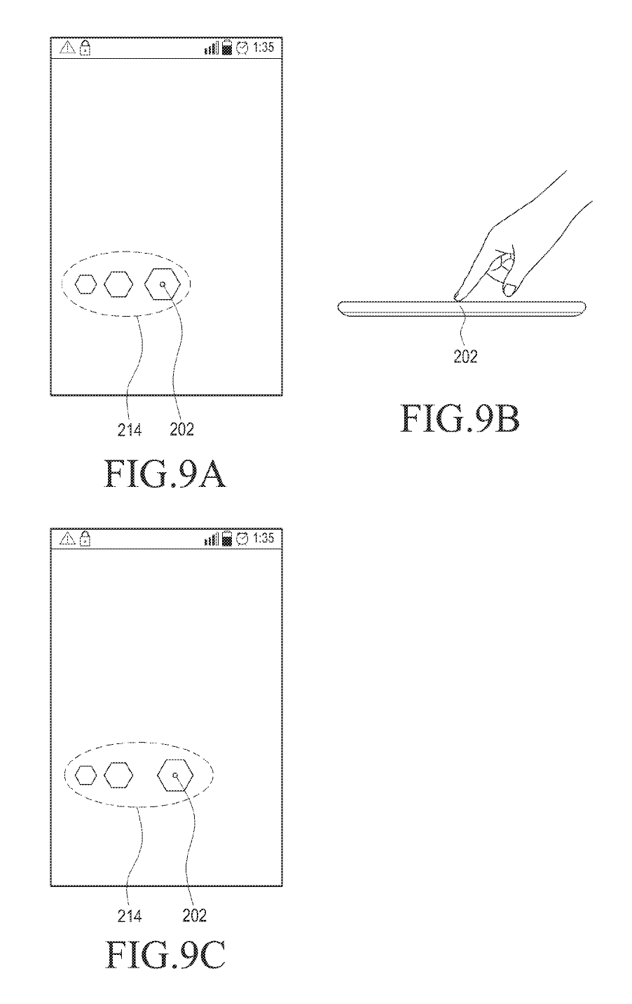

For example, if an input medium makes contact with the touch screen, as shown in FIG. 9B, the terminal may provide a visual effect in an area 214 that includes the contact point 202, as shown in FIG. 9A. The visual effect provided in the area 214 may be displaying one or more objects with at least one of the size, brightness, saturation, and transparency of the objects being different from each other. As an example, objects having different sizes are displayed in the area 214, as shown in FIG. 9A.

However, in other embodiments of the present invention, the visual effect provided in the area that includes the contact point may be different from a visual effect provided in an area that includes the hover point.

As the contact point moves, the area 214 including the contact point may also move along the contact point with a change in at least one of the size and shape of the area 214. Also, as the contact point moves, the objects included in the area 214 having the contact point may move with different acceleration or different velocity, as described with reference to FIGS. 4A-4E.

For example, as shown in FIG. 9C, while the contact point 202 is moving, the shape of the area 214 may be changed to be stretched longer in the direction in which the contact point moves, or the gap from one object to another may increase by applying different acceleration or different velocity to the objects included in the area 214.

In some embodiments of the present invention, if the contact of the input medium is released, the terminal may provide a different visual effect from the visual effect that had been provided before the contact. Providing the visual effect may be performed in the screen-locked state of the terminal. If an activity of the input medium, such as a touch, a touch and drag, etc., corresponds to a predetermined activity, the terminal may unlock the locked screen. When unlocking the locked screen, the terminal may provide a predetermined visual effect. The predetermined visual effect may be different from the visual effect that had been provided from when proximity of the input medium was detected to when the contact was detected. For example, when unlocking the locked screen, the terminal may provide a visual effect of creating a rainbow that is spread with the contact point as the center.

In other embodiments of the present invention, the visual effect may be provided differently, depending on the area and strength of the contact at the contact point. For example, objects included in the area 214 may be provided in different sizes, depending on the area and strength of the contact at the contact point.

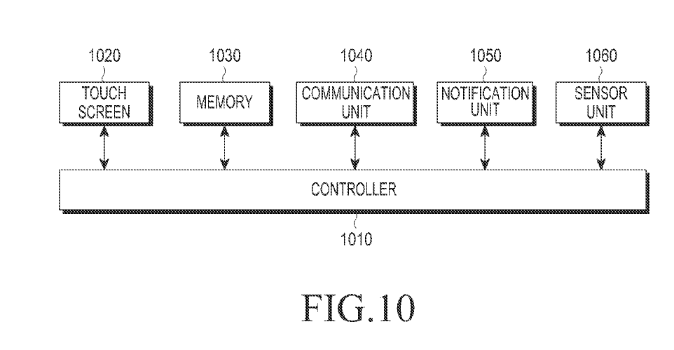

It is noted that the embodiments described above may be implemented independently or in combination. In the following, the terminal to which the embodiments of the present disclosure are applied will now be described with reference to FIG. 10.

FIG. 10 is a block diagram of the terminal to which embodiments of the present disclosure are applied.

Referring to FIG. 10, the terminal includes a controller 1010, a touch screen 1020, a memory 1030, a communication unit 1040, a notification unit 1050, and a sensor unit 1060. In some embodiments of the present invention, at least one of the elements of the terminal may be omitted, if necessary.

The controller 1010 may detect proximity and hovering of at least one input medium and provide a first visual effect on the touch screen 1020 based on a hovering position of the input medium and an attribute of an object displayed on the touch screen 1020.

For example, the controller 1010 may provide the first visual effect in a first area of the touch screen 1020, in which a hover point of the hovering input medium is included. The first visual effect may be a lighting effect by which at least one of brightness, saturation, and transparency decreases as the distance from the center of the first area increases.

In another example, the controller 1010 may provide the first visual effect in the first area of the touch screen 1020, which moves along the hover point of the hovering input medium. Specifically, the controller 1010 may provide the first visual effect in the first area that moves with acceleration between the previous hover point and the current hover point. Alternatively, the controller 1010 may provide the first visual effect in two sub-areas of the first area, which move along the hover point at different velocities. The first visual effect may be a lighting effect by which at least one of brightness, saturation, and transparency decreases as the distance from the center of each sub-area increases.

In another example, the controller 101 may provide the first visual effect in the first area that includes a hover point of the hovering input medium, the first area having a varying size based on a distance between the hovering input medium and the touch screen 1020. Specifically, the controller 1010 may provide the first visual effect in the first area that has a size inversely proportional to the distance between the hovering input medium and the touch screen 1020. The first visual effect may be a lighting effect by which at least one of brightness, saturation, and transparency is inversely proportional to the size of the first area.

Furthermore, the controller 1010 may provide a second visual effect in the form of decreasing brightness as the distance from a center of a second area increases, the second area having the same center as the first area but being different from the first area.

The controller 1010 may also provide the lighting effect in the first area that changes in size with ambient light measured by the sensor unit 1060.

Alternatively, the controller 1010 may provide the lighting effect in the form of changing at least one of brightness, saturation, and transparency with ambient light measured by the sensor unit 1060.

If there are multiple input media that are hovering over the touch screen 1020, the controller 1010 may control lighting effects for the multiple input media based on the distance between hover points of the input media.

The controller 1010 may also provide an acoustic effect through the notification unit 1050 based on the hover point of the hovering input medium. For example, the controller 1010 may perform sound panning by controlling the notification unit 1050 based on the movement of the hover point. The controller 110 may provide a different acoustic effect depending on the attribute of at least one object.

Also, the controller 1010 may provide a second visual effect in an area that includes a contact point of the input medium upon detection of a contact of the input medium with the touch screen 1020, the second visual effect being different from the first visual effect. The controller 1010 may provide the second visual effect by displaying one or more objects in an area that includes the contact point, with at least one of the size, brightness, saturation, and transparency of the objects being different from each other. The controller 1010 may apply a vibration effect to the second visual effect, upon detection of a contact of the input medium. For example, the controller 1010 may represent colors and shapes displayed according to the second visual effect in a form of being swayed or in a form of being dispersed from a particular point.

In another example, the controller 1010 may provide the first visual effect by which at least one of brightness, saturation and the size changes with color at the hover point.

The controller 1010 may stop providing the visual effect if the hovering input medium moves away beyond a predetermined threshold. The visual effect may be stopped in the form of gradually decreasing or increasing at least one of the size, brightness, saturation, and transparency. At this time, the controller 1010 may provide an acoustic effect through the notification unit 1050, indicating that the hovering input medium is moving away.

The controller 1010 may estimate a distance between the touch screen 1020 and the input medium. The controller 1010 may detect hovering of the input medium if the input medium comes within a predetermined threshold distance to the touch screen 1020. The input medium may be a part of human body, such as the user's finger, or any tool, such as an electronic pen.

The touch screen 1020 may have a structure in which a touch pad and a display module are layered. The touch pad may adopt any of resistive, capacitive, infrared, electromagnetic, and ultrasonic methods, or a combination of at least two of them. With the touch pad, the touch screen 1020 may detect at least one input medium approaching to, moving away from, hovering over and contacting the touch screen 1020. The touch screen 1020 may then create a signal in response to the detection of the activity of the input medium, and send the signal to the controller 1010.

The touch screen 1020 may also display at least one object and at least one visual effect.

The memory 1030 may include various programs, displayable objects, and sound sources for sound output. The objects may have metadata and tag information attached thereto. In some embodiments of the present invention, the memory 1030 may match and store information regarding attributes of the objects.

The communication unit 1040 may communicate with the outside using many different communication schemes and transmit or receive information about a particular object under control of the controller 1010.

The notification unit 1050 may include a speaker and a vibration motor. The notification unit 1050 may provide a notification effect based on at least one of proximity, move-away and hovering of the input medium, under control of the controller 1010.

The sensor unit 1060 may include at least one sensor. The sensor unit 1060 may include an illumination sensor, which measures illuminance around the terminal and passes the result to the controller 1010.

The sensor unit 1060 may also include a proximity sensor for detecting proximity of an input medium, which measures the distance to the input medium and passes the result to the controller 1010.

Embodiments of the present invention are advantageous in that they improve user experience. In the embodiments of the present invention, improvement of user experience may be achieved by providing the user with visual and acoustic effects based on the position of an input medium.

The foregoing embodiments of the present invention may be implemented in many different methods. For example, the embodiments of the present invention may be implemented in hardware, software, or a combination thereof. When implemented in software, the embodiments of the present invention may be implemented with instructions, executable by one or more processors with various operating systems or platforms. Additionally, the software may be written in any of different proper programming languages, and/or may be compiled into machine-executable assembly language codes or intermediate codes, which are executed on a framework or a virtual machine.

Furthermore, the embodiments of the present invention may be implemented on processor-readable media (e.g., memories, floppy discs, hard discs, compact discs, optical discs, or magnetic tapes) having one or more programs embodied thereon for carrying out, when executed by one or more processors, the method of implementing embodiments of the present invention described in detail above.

Various embodiments of the present invention may be embodied as computer-readable codes on a computer-readable recording medium. The computer-readable recording medium is any data storage device that can store data, which can be thereafter read by a computer system. Examples of the computer readable recording medium include ROM, RAM, Compact Disc (CD)-ROMs, magnetic tapes, floppy disks, optical data storage devices, etc. The computer readable recording medium can also be distributed over network coupled computer systems so that the computer readable code is stored and executed in a distributed fashion.

In accordance with an aspect of the present disclosure, a method for providing a user interface is provided. The method includes displaying at least one object on a touch screen; detecting hovering of at least one input medium over the touch screen; and providing a first visual effect based on where the input medium hovers over the touch screen and based on an attribute of the at least one object.

In an embodiment, wherein the providing the first visual effect comprises providing the first visual effect in a first area of the touch screen that includes a hover point over which the at least one input medium hovers.

In an embodiment, wherein the providing the first visual effect comprises providing a lighting effect by decreasing at least one of brightness, saturation, and transparency as a distance on the touch screen from a center of the first area increases.

In an embodiment, wherein the providing the first visual effect comprises providing the first visual effect in a first area of the touch screen that moves with a hover point over which the at least one input medium hovers.

In an embodiment, wherein the providing the first visual effect comprises providing the first visual effect in the first area that moves with acceleration between a previous hover point and a current hover point.

In an embodiment, wherein the providing the first visual effect comprises providing the first visual effect in each of at least two sub-areas, the at least two sub-areas being included in the first area and moving with the hover point at different velocity.

In an embodiment, wherein the providing the first visual effect comprises providing a lighting effect by decreasing at least one of brightness, saturation, and transparency as a distance on the touch screen from a center of each of the at least two sub-areas increases.

In an embodiment, wherein the providing the first visual effect comprises providing the first visual effect in a first area that includes a hover point over which the at least one input medium hovers and that changes in size based on a distance between the at least one hovering input medium and the touch screen.

In an embodiment, wherein providing the first visual effect comprises providing the first visual effect in the first area that has a size inversely proportional to a distance between the at least one hovering input medium and the touch screen.

In an embodiment, wherein the providing the first visual effect comprises providing a lighting effect such that at least one of brightness, saturation, and transparency is inversely proportional to a size of the first area.

In an embodiment, the method further comprises providing a second visual effect by decreasing the brightness as a distance on the touch screen from a center of a second area increases, the second area having a same center as the center of the first area but being different from the first area.

In an embodiment, the method further comprises measuring ambient light, wherein providing the lighting effect comprises providing the lighting effect in the first area that changes in size with an amount of the ambient light.

In an embodiment, the method further comprises measuring ambient light, wherein providing the lighting effect comprises providing the lighting effect by changing at least one of brightness, saturation, and transparency with an amount of the ambient light.

In an embodiment, the method further comprises when the at least one input medium comprises a plurality of input media hovering over the touch screen, controlling lighting effects for the plurality of input media based on a distance between respective hover points of the plurality of input media.

In an embodiment, the method further comprises providing an acoustic effect based on a hover point of the at least one input medium.

In an embodiment, wherein providing the acoustic effect comprises outputting a sound based on a movement of the hover point.

In an embodiment, wherein providing the acoustic effect comprises providing different acoustic effects depending on the attribute of the at least one object.

In an embodiment, the method further comprises providing a second visual effect in an area that includes a contact point of the at least one input medium upon detecting contact of the input medium with the touch screen, the second visual effect being different from the first visual effect.

In an embodiment, wherein providing the second visual effect comprises displaying one or more objects with at least one of brightness, saturation, and transparency being different from each other, in an area that includes the contact point.

In an embodiment, the method further comprises applying a vibration effect to the second visual effect upon detecting contact of the at least one input medium with the touch screen.

In an embodiment, wherein providing the first visual effect comprises providing the first visual effect with at least one of brightness, saturation, and a size being different depending on a color of the at least one input medium.

In accordance with another aspect of the present disclosure, an apparatus for providing a user interface is provided. The apparatus includes a touch screen for displaying at least one object and detecting proximity or contact of at least one input medium; and a controller configured to control the touch screen to detect proximity and hovering of the at least one input medium and provide a first visual effect on the touch screen based on where the input medium hovers over the touch screen and based on an attribute of the at least one object.

In an embodiment, wherein the controller is configured to provide the first visual effect in a first area of the touch screen that includes a hover point over which the at least one input medium hovers.

In an embodiment, wherein the controller is configured to provide a lighting effect by decreasing at least one of brightness, saturation, and transparency as a distance on the touch screen from a center of the first area increases.

In an embodiment, wherein the controller is configured to provide the first visual effect in a first area of the touch screen that moves with a hover point over which the at least one input medium hovers.

In an embodiment, wherein the controller is configured to provide the first visual effect in the first area that moves with acceleration between a previous hover point and a current hover point.

In an embodiment, wherein the controller is configured to provide the first visual effect in each of at least two sub-areas, the at least two sub-areas being included in the first area and moving with the hover point at different velocity.

In an embodiment, wherein the controller is configured to provide a lighting effect by decreasing at least one of brightness, saturation, and transparency as a distance on the touch screen from a center of each of the at least two sub-areas increases.

In an embodiment, wherein the controller is configured to provide the first visual effect in a first area that includes a hover point over which the at least one input medium hovers and that changes in size based on a distance between the at least one hovering input medium and the touch screen.

v, wherein the controller is configured to provide the first visual effect in the first area that has a size inversely proportional to a distance between the at least one hovering input medium and the touch screen.

In an embodiment, wherein the controller is configured to provide a lighting effect such that at least one of brightness, saturation, and transparency is inversely proportional to a size of the first area.

In an embodiment, wherein the controller is configured to provide a second visual effect by decreasing the brightness as a distance on the touch screen from a center of a second area increases, the second area having a same center as the center of the first area but being different from the first area.

In an embodiment, the apparatus further comprises a sensor unit for measuring ambient light, wherein the controller is configured to provide the lighting effect in the first area that changes in size with an amount of the ambient light.

In an embodiment, the apparatus further comprises a sensor unit for measuring ambient light, wherein the controller is configured to provide the lighting effect by changing at least one of brightness, saturation and transparency with an amount of the ambient light.

In an embodiment, wherein, when the at least one input medium comprises a plurality of input media hovering over the touch screen, the controller is configured to control lighting effects for the plurality of input media based on a distance between respective hover points of the plurality of input media.

In an embodiment, the apparatus further comprises a notification unit, wherein the controller is configured to provide an acoustic effect through the notification unit based on a hover point of the at least one input medium.

In an embodiment, wherein the controller is configured to output a sound by controlling the notification unit based on a movement of the hover point.

In an embodiment, wherein the controller is configured to provide different acoustic effects depending on the attribute of the at least one object.

In an embodiment, wherein the controller is configured to provide a second visual effect in an area that includes a contact point of the at least one input medium upon detecting contact of the input medium with the touch screen, the second visual effect being different from the first visual effect.

In an embodiment, wherein the controller is configured to display one or more objects with at least one of brightness, saturation, and transparency being different from each other, in an area that includes the contact point.

In an embodiment, the apparatus further comprises a notification unit, wherein the controller is configured to apply a vibration effect to the second visual effect, upon detecting contact of the at least one input medium with the touch screen.

In an embodiment, wherein the controller is configured to provide the first visual effect with at least one of brightness, saturation, and a size being different depending on a color of the at least one input medium.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A method for providing a user interface, the method comprising the steps of:
displaying at least one object on a touch screen;
detecting hovering of at least one input medium over the touch screen; and
providing a first visual effect based on where the input medium hovers over the touch screen and based on an attribute of the at least one object.

2. The method of claim 1, wherein providing the first visual effect comprises providing the first visual effect in a first area of the touch screen that includes a hover point over which the at least one input medium hovers.

3. The method of claim 2, wherein providing the first visual effect comprises providing a lighting effect by decreasing at least one of brightness, saturation, and transparency as a distance on the touch screen from a center of the first area increases.

4. The method of claim 1, wherein providing the first visual effect comprises providing the first visual effect in a first area of the touch screen that moves with a hover point over which the at least one input medium hovers.

5. The method of claim 4, wherein providing the first visual effect comprises providing the first visual effect in the first area that moves with acceleration between a previous hover point and a current hover point.

6. The method of claim 4, wherein providing the first visual effect comprises providing the first visual effect in each of at least two sub-areas, the at least two sub-areas being included in the first area and moving with the hover point at different velocity.

7. The method of claim 1, wherein providing the first visual effect comprises providing the first visual effect in a first area that includes a hover point over which the at least one input medium hovers and that changes in size based on a distance between the at least one hovering input medium and the touch screen.

8. The method of claim 3, further comprising:
providing a second visual effect by decreasing the brightness as a distance on the touch screen from a center of a second area increases, the second area having a same center as the center of the first area but being different from the first area.

9. The method of claim 3, further comprising:
measuring ambient light,
wherein providing the lighting effect comprises providing the lighting effect in the first area that changes in size with an amount of the ambient light.

10. The method of claim 3, further comprising:
when the at least one input medium comprises a plurality of input media hovering over the touch screen, controlling lighting effects for the plurality of input media based on a distance between respective hover points of the plurality of input media.

11. The method of claim 1, further comprising:
providing an acoustic effect based on a hover point of the at least one input medium.

12. The method of claim 1, further comprising:
providing a second visual effect in an area that includes a contact point of the at least one input medium upon detecting contact of the input medium with the touch screen, the second visual effect being different from the first visual effect.

13. The method of claim 12, further comprising:
applying a vibration effect to the second visual effect upon detecting contact of the at least one input medium with the touch screen.

14. An apparatus for providing a user interface, the apparatus comprising:
a touch screen for displaying at least one object and detecting proximity or contact of at least one input medium; and
a controller configured to control the touch screen to detect proximity and hovering of the at least one input medium and provide a first visual effect on the touch screen based on where the input medium hovers over the touch screen and based on an attribute of the at least one object.

15. The apparatus of claim 14, wherein the controller is configured to provide the first visual effect in a first area of the touch screen that includes a hover point over which the at least one input medium hovers.

16. The apparatus of claim 14, wherein the controller is configured to provide the first visual effect in a first area of the touch screen that moves with a hover point over which the at least one input medium hovers.

17. The apparatus of claim 16, wherein the controller is configured to provide the first visual effect in each of at least two sub-areas, the at least two sub-areas being included in the first area and moving with the hover point at different velocity.

18. The apparatus of claim 14, wherein the controller is configured to provide the first visual effect in a first area that includes a hover point over which the at least one input medium hovers and that changes in size based on a distance between the at least one hovering input medium and the touch screen.

19. The apparatus of claim 15, wherein the controller is configured to provide a second visual effect by decreasing the brightness as a distance on the touch screen from a center of a second area increases, the second area having a same center as the center of the first area but being different from the first area.

20. The apparatus of claim 15, further comprising:
a sensor unit for measuring ambient light,
wherein the controller is configured to provide the lighting effect in the first area that changes in size with an amount of the ambient light.
